(19) United States
(12) Patent Application Publication
(10) Pub. No.: US 2005/0051386 A1
(43) Pub. Date: Mar. 10, 2005

(54) Ladder support brace

(76) Inventor: Dennis Simpson, Minnetonka, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/895,274

(22) Filed: Jul. 20, 2004

Related U.S. Application Data
(60) Provisional application No. 60/500,505, filed on Sep. 5, 2003.

(51) Int. Cl. E06C 7/10

(52) U.S. Cl. 182/217; 182/220

(57) ABSTRACT

A ladder including a first ladders rail, a second ladder rail, a first step and a support brace. The first ladder rail has a first rail front side, a first rail rear side, and a first rail web that extends between the first rail front side and the first rail rear side. The second ladder rail has a second rail front side, a second rail rear side, and a second rail web that extends between the second rail front side and the second rail rear side. The first step is attached to the first ladder rail and the second ladder rail.

### PRIORITY CLAIM

This application claims priority to United States Provisional Application No. 60/500,505, filed on Sep. 5, 2003, entitled LADDER SUPPORT BRACE, which is incorporated herewith.

### FIELD OF THE INVENTION

The invention relates generally to ladders. More particularly, the invention relates to a support brace for ladders.

### BACKGROUND OF THE INVENTION

Stepladders are generally known in the art. Kummerlin, U.S. Pat. No. 4,502,564, discloses a foldable stepladder. In many instances, stepladders provide a stable means to climb and access areas that were previously out of reach. However, a substantial number of stepladders are inherently unstable because of the ladder construction, certain manufacturing processes, harsh usage, or because of their age.

To address the need for additional stability, various types of support structures have been developed to address needs in this area. Some examples of ladder support structures are disclosed in the following patents: Plotner et al., U.S. Pat. Nos. 6,142,255; 5,791,439; 5,636,706; and Bailey, U.S. Pat. No. 4,949,811.

In particular, the Plotner et al. patents disclose a ladder brace having a U-shaped configuration. The Plotner et al. patents indicate the first brace side, the second brace side and the brace web are adjacent the first rail side, the second rail side and the rail web, respectively, to transfer forces therebetween.

### SUMMARY OF THE INVENTION

A ladder according to an embodiment of the invention includes a first ladder rail having a first rail front side, a first rail rear side, and a first rail web that extends between the first rail front side and the first rail rear side. The ladder also includes a second ladder rail having a second rail front side, a second rail rear side, and a second rail web that extends between the second rail front side and the second rail rear side. In addition, the ladder includes a first step attached to the first ladder rail, the second ladder rail and a support brace.

The support brace includes a first brace section having a first brace front side, a first brace rear side, and a first brace web that extends between the first brace front side and the first brace rear side. The first rail front side is attached to the first brace front side. The first rail rear side is attached to the first brace rear side. The first rail web and the first brace web are opposite each other.

The support brace further includes a second brace section having a second brace front side, a second brace rear side, and a second brace web that extends between the second brace front side and the second brace rear side. The second rail front side is attached to the second brace front side. The second rail rear side is attached to the second brace rear side. The second rail web and the second brace web are opposite each other.

The support brace is separately attached to the rails of the ladder or, optionally, the support brace is integrally molded with the first step of the ladder or first cross-support of the ladder and the combination is attached to the rails of the ladder.

### BRIEF DESCRIPTION OF THE DRAWINGS

FIG. 1 is a perspective view of a stepladder according to an embodiment of the invention.

FIG. 2 is a perspective view of the front ladder section of the stepladder.

FIG. 3 is a perspective view of the rear ladder section of the stepladder.

FIG. 4 is a front view of a front support brace.

FIG. 5 is a perspective view of a left side of the support brace.

FIG. 6 is a perspective view of a right side of the support brace.

FIG. 7 is a front view of an alternative configuration of the support brace.

FIG. 8 is a perspective view of the support brace attached to the front ladder section.

FIG. 9 is a sectional view of the support brace attached to the front ladder section taken along a line 9--9 in FIG. 8.

FIG. 10 is an outside view of a front brace portion and a rear brace portion of the support brace.

FIG. 11 is an inside view of the front brace portion and the rear brace portion.

FIG. 12 is a close-up view of the front brace portion.

FIG. 13 is a close-up view of the rear brace portion.

FIG. 14 is a close-up perspective view of a cylindrical-shaped rear post.

FIG. 15 is a perspective view of the support brace depicting the engagement of a front post and rear post.

FIG. 16 is a perspective view of a front foot cap.

FIG. 17 is a perspective view of a rear foot cap.

FIG. 18 is a front view of a rear support brace.

FIG. 19 is a perspective view of another support brace.

FIG. 20 is a lower view of the support brace of FIG. 19.

### DETAILED DESCRIPTION OF THE DRAWINGS

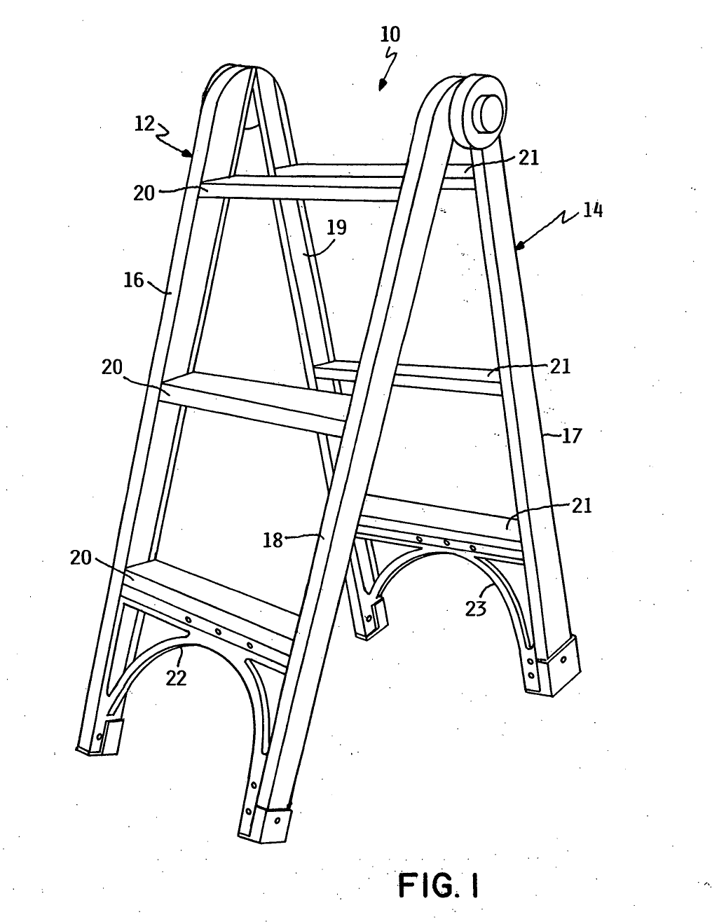

A ladder 10 according to an embodiment of the invention generally consists of a front ladder section 12 pivotally attached to a rear ladder section 14, as depicted in FIG. 1. The front ladder section 12 and the rear ladder section 14 preferably each have a support brace 22, 23 attached thereto.

The support braces 22, 23 prevent the ladder from swaying from side to side. The support braces 22, 23 also enhance the overall strength of the ladder. Furthermore, because the preferred construction material of the support braces 22, 23 is plastic, the support braces 22, 23 only add a very nominal amount of weight to the ladder 10. However, in another embodiment, the support braces 22, 23 are constructed of metal, where some weight added to the ladder is of less consequence as compared to the additional strength provided by the metal support braces 22, 23.

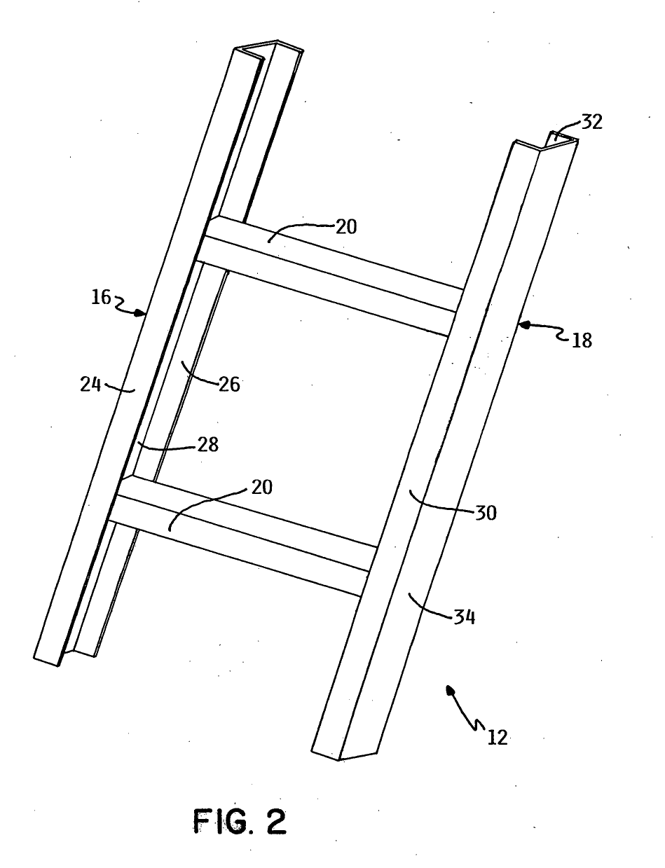

The front ladder section 12 includes a first rail 16 mounted with respect to a second rail 18. Referring to FIG. 2, the first rail 16 includes a first rail front side 24, a first rail rear side 26, and a first rail web 28 that extends between the first rail front side 24 and the first rail rear side 26 to preferably provide the first rail 16 with a U-shaped configuration.

Similarly, the second rail 18 includes a second rail front side 30, a second rail rear side 32, and a second rail web 34 that extends between the second rail front side 30 and the second rail rear side 32 to preferably provide the second rail 18 with a U-shaped configuration.

The front ladder section 12 further includes a plurality of steps 20 that extend between the first rail 16 and the second rail 18 and are preferably substantially perpendicular to the first rail 16 and the second rail 18.

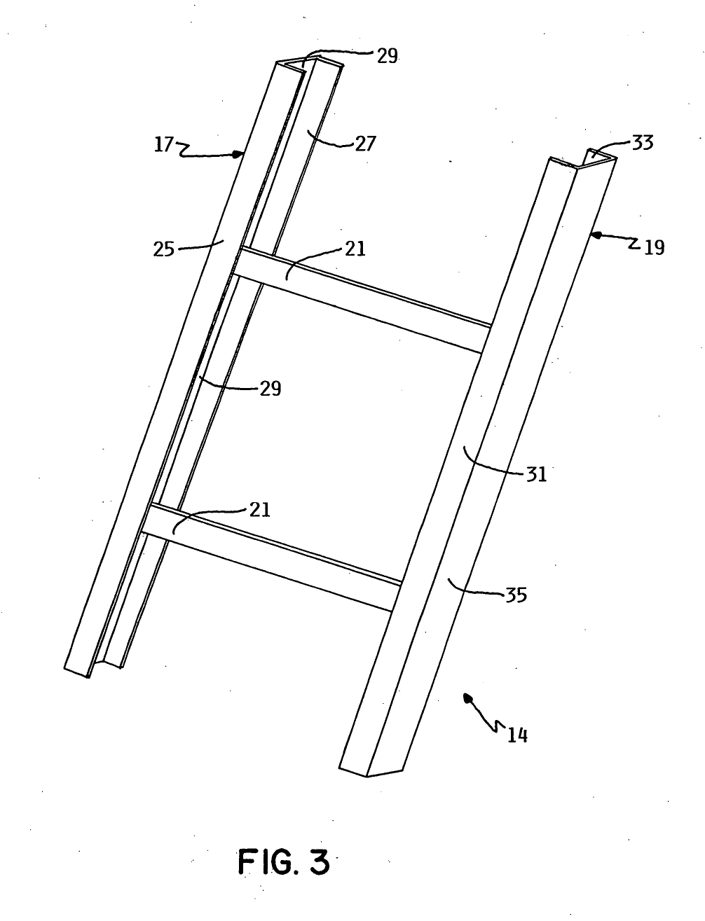

The rear ladder section 14 includes a third rail 17 mounted with respect to a fourth rail 19. Referring to FIG. 3, the third rail 17 includes a third rail front side 25, a third rail rear side 27, and a third rail web 29 that extends between the third rail front side 25 and the third rail rear side 27 to preferably provide the third rail 17 with a U-shaped configuration.

Similarly, the fourth rail 19 includes a fourth rail front side 31, a fourth rail rear side 33, and a fourth rail web 35 that extends between the fourth rail front side 31 and the fourth rail rear side 33 to preferably provide the fourth rail 19 with a U-shaped configuration.

The rear ladder section 14 further includes a plurality of cross-supports 21 that extend between the third rail 17 and the fourth rail 19 and are preferably substantially perpendicular to the third rail 17 and the fourth rail 19. A person of ordinary skill in the art will appreciate that the rear ladder section 14 may include a plurality of steps instead of the cross-supports 21 so that a person can climb on the rear ladder section 14 similar to the front ladder section 12.

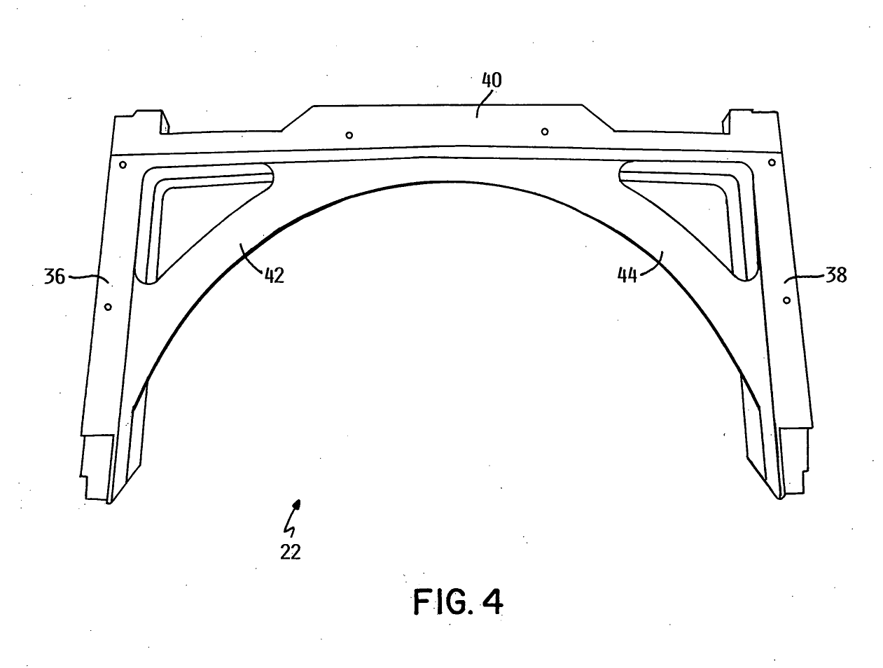

The front support brace 22 is provided on the front ladder section 12. The front support brace 22, as depicted in FIG. 4, generally includes a first brace section 36, a second brace section 38, a central brace section 40, a first support 42, and a second support 44.

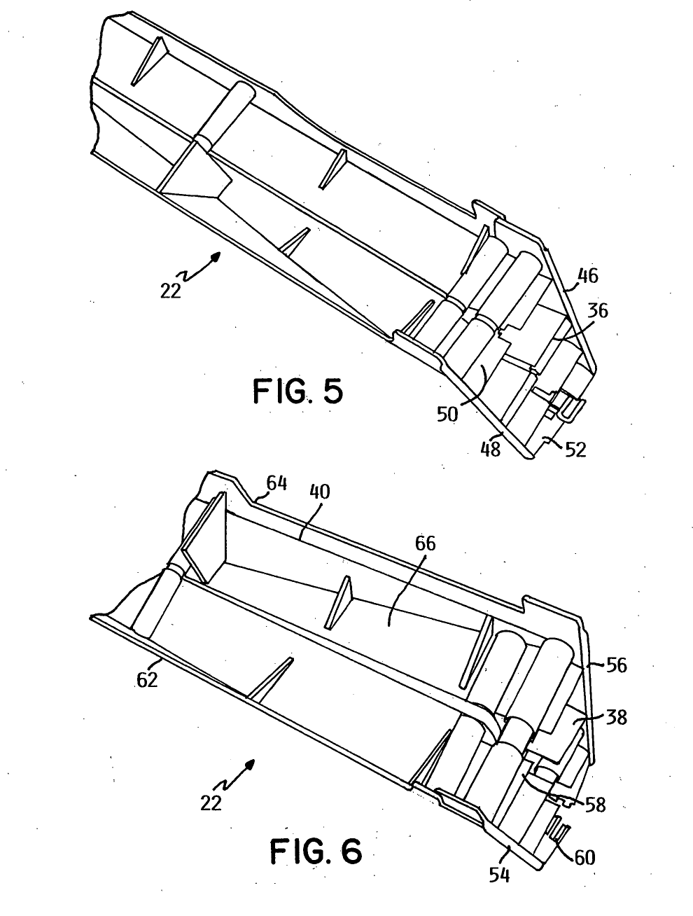

Referring to FIG. 5, the first brace section 36 generally includes a first brace front side 46, a first brace rear side 48, a first brace web 50 that extends between the first brace front side 46 and the first brace rear side 48, and a first brace base 52.

Referring to FIG. 6, the second brace section 38 generally includes a second brace front side 54, a second brace rear side 56, a second brace web 58 that extends between the second brace front side 54 and the second brace rear side 56, and a second brace base 60.

The central brace section 40 is preferably integrally attached between the first brace section 36 and the second brace section 38 and generally includes a central brace front side 62, a central brace rear side 64, and a central brace web 66 that extends from the central brace front side 62 to the central brace rear side 64.

Referring to FIG. 4, the first support 42 is preferably integrally attached to the first brace section 36 and the central brace section 40. The first support 42 preferably has an arched configuration. The second support 44 is preferably integrally attached to the second brace section 38 and the central brace section 40. The second support 44 preferably has an arched configuration.

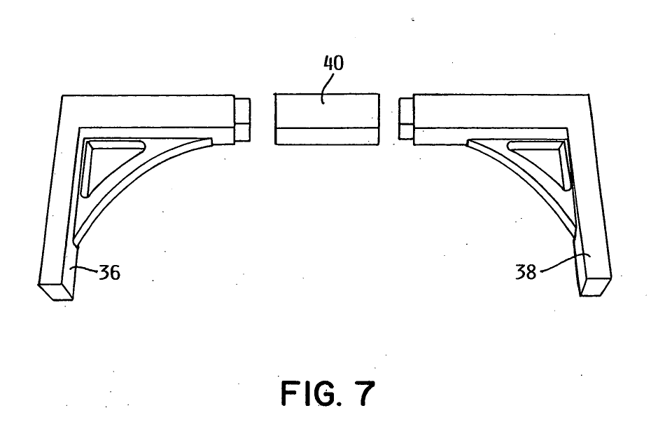

In an alternative embodiment, which is illustrated in FIG. 7, the central brace section 40 is separate from the first brace section 36 and the second brace section 38. This configuration enables a length of the central brace section 40 to be varied depending on a width of the front ladder section 12.

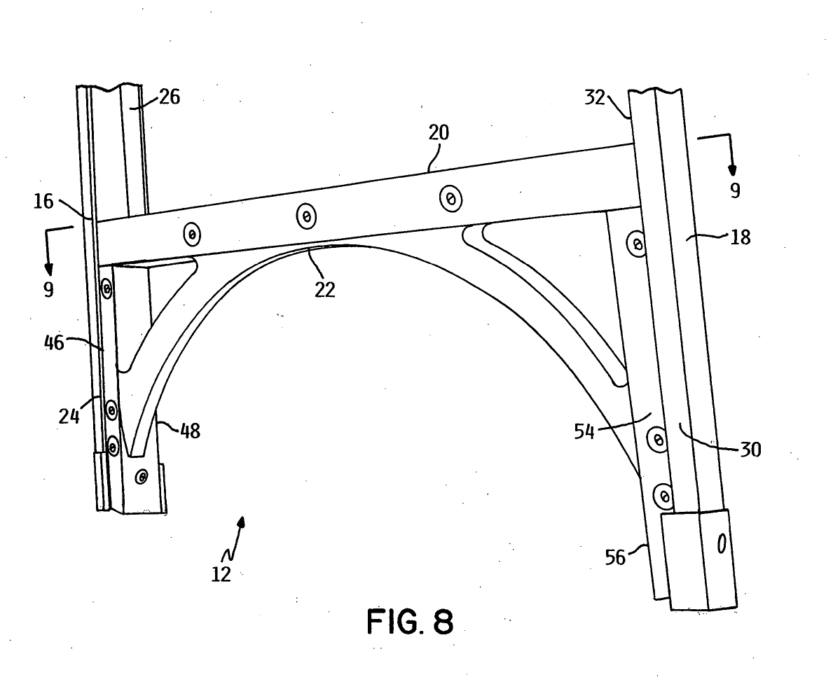

Referring to FIG. 8, the front support brace 22 is fixedly attached to the first rail 16 and the second rail 18. In a preferred embodiment, the front support brace 22 is attached below a first step 20 of the front ladder section 12. The first rail front side 24 is fixedly attached to the first brace front side 46 and the first rail rear side 26 is fixedly attached to the first brace rear side 48. The second rail front side 30 is attached to the second brace front side 54 and the second rail rear side 32 is attached to the second brace rear side 56.

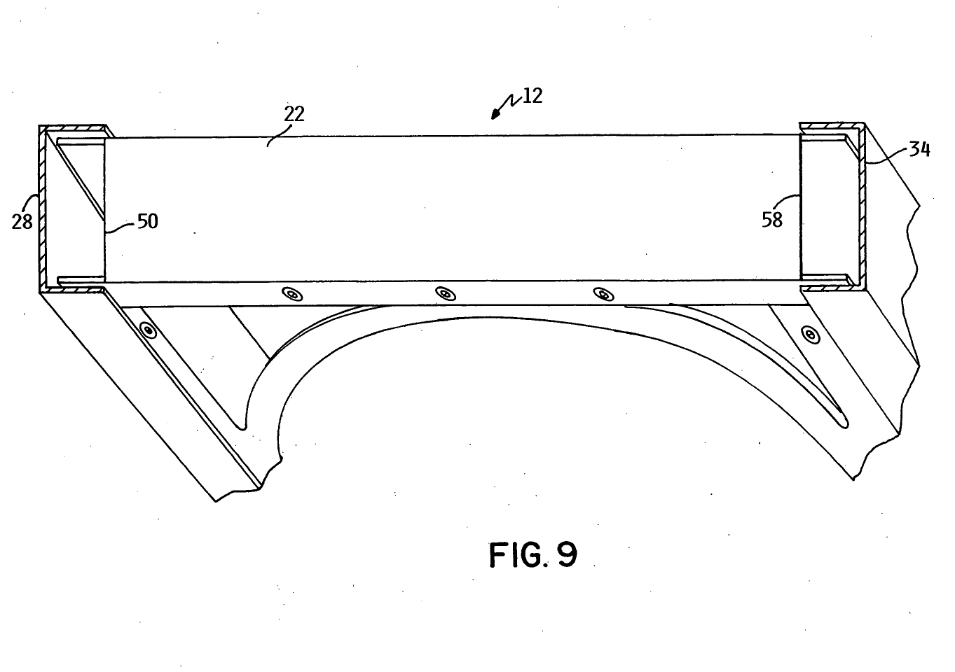

Referring to FIG. 9, when the front support brace 22 is attached to the front ladder section 12, the first rail web 28 is preferably substantially opposite the first brace web 50. The second rail web 34 is preferably substantially opposite the second brace web 58. This configuration provides the first support brace 22, and more generally the ladder 10, with excellent rigidity and additional support and strength.

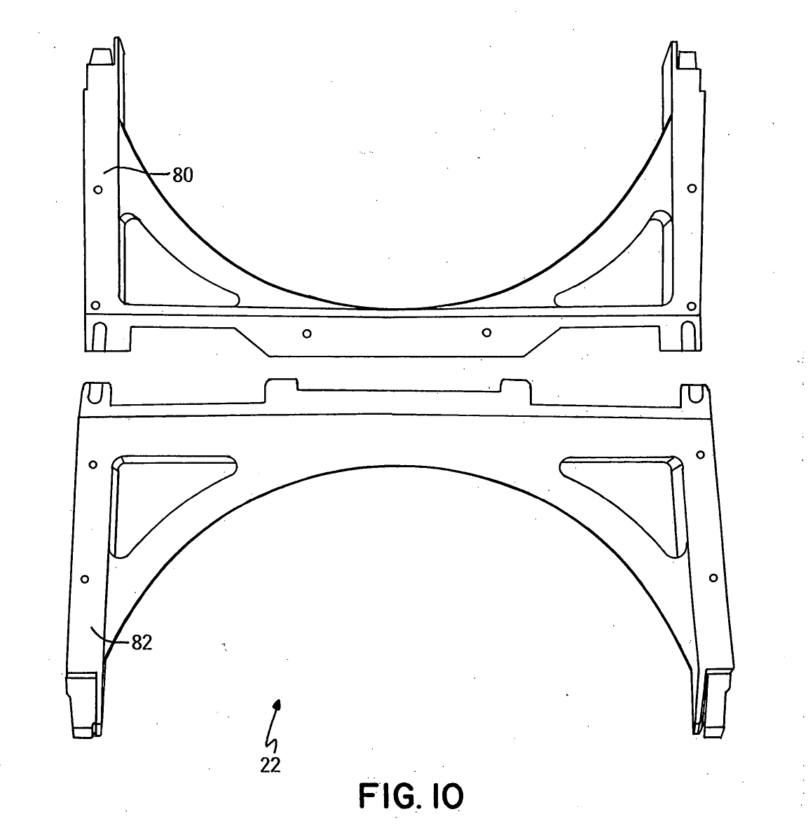

In one embodiment of the invention, as can be seen in FIG. 10, the front support brace 22 includes a front brace portion 80 and a rear brace portion 82. Using a two-part configuration facilitates fabricating of the front support brace 22 using injection molding.

Referring to FIG. 11, the front brace portion 80 preferably includes a plurality of substantially cylindrical-shaped front posts 96 extending from a back side thereof. The front posts 96 are preferably oriented in a spaced-apart configuration to enhance the strength of the front support brace 22.

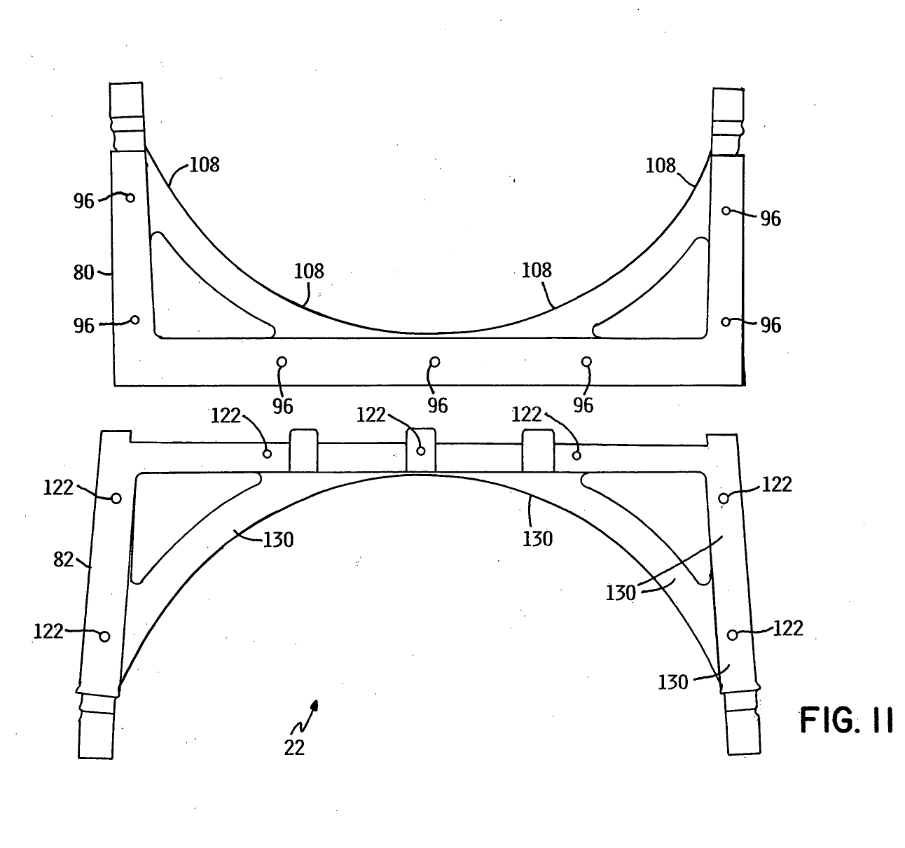

As depicted in FIG. 12, the front posts 96 preferably include a front post outer radius 98, a front brace aperture 100, a shoulder 102, a front post end 104, and a reduced-radius portion 106 proximate the front post end 104. The front brace apertures 100 preferably extend through the cylindrical-shaped front posts 96.

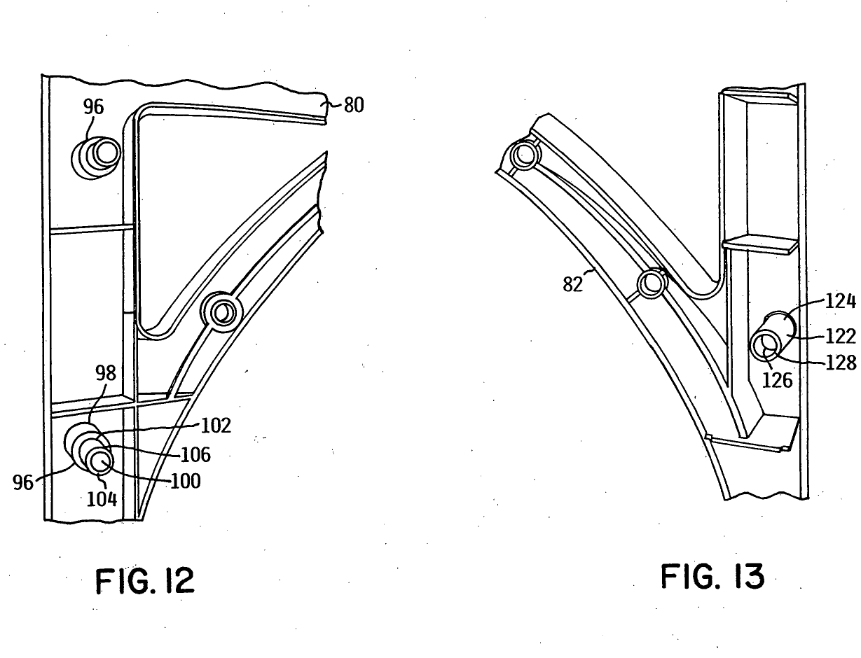

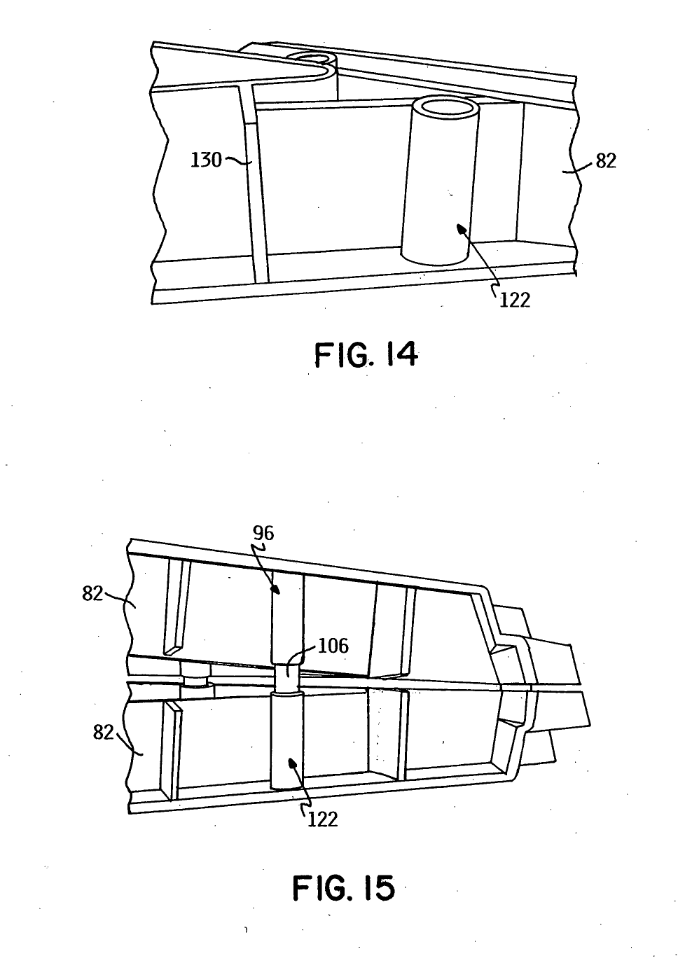

Referring to FIG. 11, the rear brace portion 82 preferably includes a plurality of substantially cylindrical-shaped rear posts 122 extending from a back side thereof. As depicted in FIG. 13, the rear posts 122 include a rear post outer radius 124, a rear brace aperture 126, and a rear post end 128. The rear brace apertures 126 preferably extend through the cylindrical-shaped rear posts 122 and have substantially the same radius as the reduced-radius portion 106.

When the front brace portion 80 and the rear brace portion 82 are attached to the first rail 16 and the second rail 18, the front posts 96 substantially align with the rear posts 122. As illustrated in FIGS. 5 and 6, the reduced-radius portions 106 slidably insert into the rear brace apertures 126 until the shoulders 102 substantially abut the rear post ends 128.

In an embodiment of the invention, rivets are used to attach the front brace portion 80 to the rear brace portion 82. However, it is contemplated that any fastener can be used to attach the front brace portion 80 to the rear brace portion 82, such as bolts, screws, nails, pegs, dowels, or any other fastener.

Referring to FIG. 11, the front brace portion 80 preferably includes a plurality of front reinforcing members 108 extending from a back side thereof. The front reinforcing members 108 enhance the rigidity of the front support brace 22. The rear brace portion 82 preferably includes a plurality of rear reinforcing members 130 substantially identical to the front reinforcing members 108.

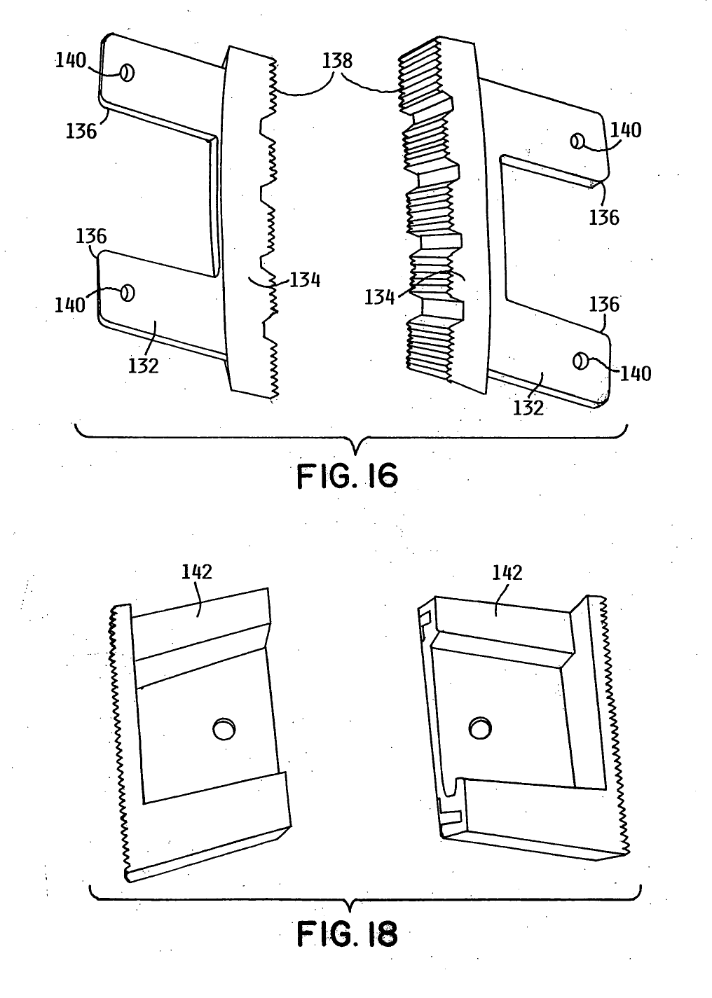

Referring to FIG. 16, the front support brace 22 preferably includes a plurality of foot caps 132 that may be fixedly attached to the first brace base 52 and the second brace base 60. The foot caps 132 generally include a foot cap base 134 having a bottom surface 138 and a foot cap post 136 that extends from the foot cap base 134.

The foot cap post 136 preferably includes at least one aperture 140 for attaching the foot cap 132 to the first brace section 36 or second brace section 38 once the foot cap is slidably engaged with the first brace section 36 or the second brace section 38. The bottom surface 138 is preferably textured and the foot caps 132 are preferably constructed of a material with a high coefficient of friction.

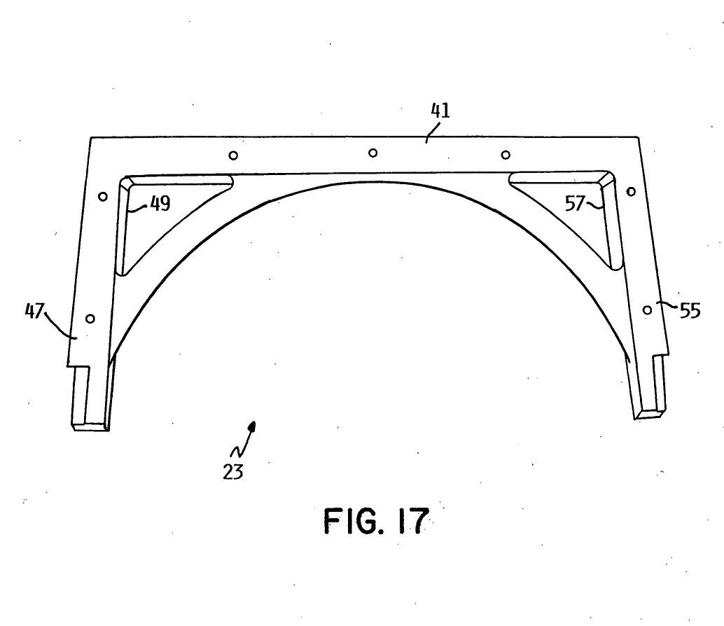

Referring to FIGS. 1, 3 and 17, the rear ladder section 14 preferably includes the rear support brace 23 that is shaped similar to the front support brace 22. As the structure of the front support brace 22 and the rear support brace 23 is similar, the details on the structure of the rear support brace 23 are being omitted. The rear support brace 23 is fixedly attached to the third rail 17 and the fourth rail 19. In a preferred embodiment, the rear support brace 23 is attached below a first cross-support 21 of the rear ladder section 14. The third rail front side 25 is fixedly attached to the first brace front side 47, the third rail rear side 27 is fixedly attached to the first brace rear side 49. The fourth rail front side 31 is attached to the second brace front side 55 and the fourth rail rear side 33 is attached to the second brace rear side 57. The central brace section 41 of the rear support brace is fixedly attached to the underside of the cross-support 21.

In another embodiment of the invention, the rear support brace 23 is integrally molded with the first cross-support 21, forming a cross-support assembly. Referring to FIGS. 1, 3 and 17, the central brace section 41 of the rear support brace 23 is integrally attached to the underside of cross-support 21 of the rear ladder section 14.

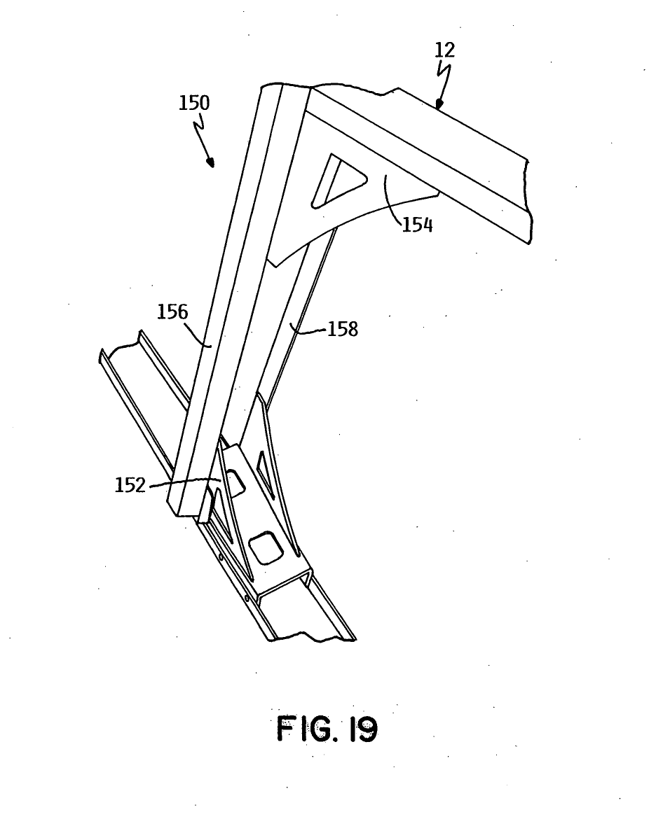

Similar to the attachment of the step assembly, comprising the first step 20 and front support brace 22, to the front ladder section 12, the cross-support assembly, comprising the cross-support 21 and rear support brace 23, is fixedly attached to the rear ladder section 14. The cross-support assembly is fixedly attached to the third rail 17 and the fourth rail 19. The first brace front side 47 is fixedly attached to the third rail front side 25 and the first brace rear side 49 is attached to the third rail rear side 27. The second brace front side 55 is fixedly attached to the fourth rail front side 31 and the second brace rear side 57 is attached to the fourth rail rear side 33. An alternate embodiment of a foot cap 142 can be seen in FIG. 18.

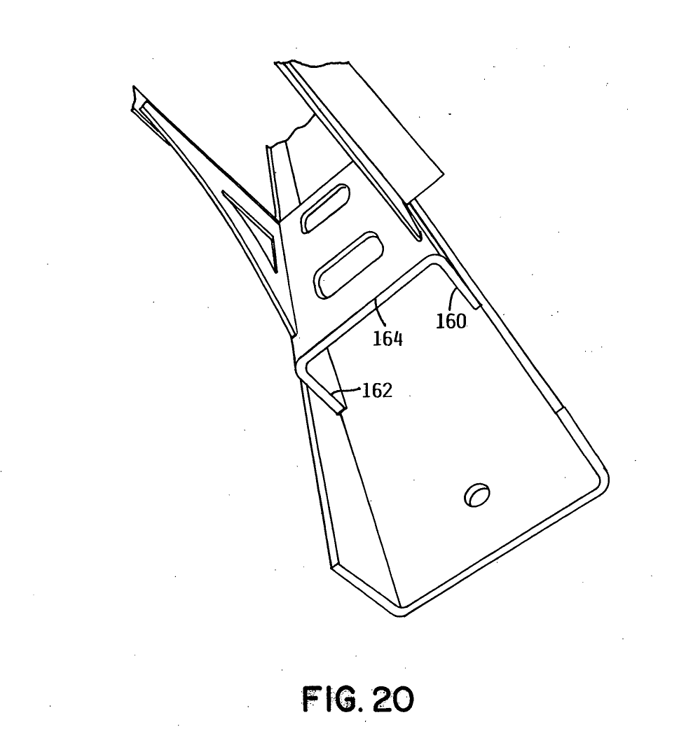

In another embodiment of the invention, the support brace is integrally formed with a step of the front ladder section 12 to form a step assembly 150, as illustrated in FIGS. 19 and 20. The step assembly 150 includes a first brace section 152, a second brace section 154, a step 156, and a central brace section 158. Integrally forming these components not only enhances the rigidity of the ladder but also reduces the steps associated with manufacturing the ladder.

Similar to the embodiment illustrated in FIG. 4, the first brace section 152 and the second brace section 154 each include a brace front side 160, a brace rear side 162, and a brace web 164 that extends between the first brace front side 160 and the first brace rear side 162, and a first brace base 52.

The step 156 is integrally attached to the brace front sides 160. The step 156 preferably has a substantially square configuration with an upper surface 170 having width that is sufficiently large to facilitate a person standing on the step 156. The upper surface 170 may also have a texture to enhance the traction of the step 156.

The central brace section 158 is integrally attached to the brace rear sides 162. The step 156 and the central brace section 158 are mounted in a spaced-apart relationship to facilitate slidably mounting a ladder to the first ladder section 12.

It is contemplated that features disclosed in this application, as well as those described in the above applications incorporated by reference, can be mixed and matched to suit particular circumstances. Various other modifications and changes will be apparent to those of ordinary skill.

1. A ladder comprising:
a first ladder rail having a first rail front side, a first rail rear side, and a first rail web that extends between the first rail front side and the first rail rear side;
a second ladder rail having a second rail front side, a second rail rear side, and a second rail web that extends between the second rail front side and the second rail rear side;
a first step attached to the first ladder rail and the second ladder rail;
a support brace comprising;
a first brace section having a first brace front side, a first brace rear side, and a first brace web that extends between the first brace front side and the first brace rear side, wherein the first rail front side is attached to the first brace front side, wherein the first rail rear side is attached to the first brace rear side, and wherein the first rail web and the first brace web are opposite each other;
a second brace section having a second brace front side, a second brace rear side, and a second brace web that extends between the second brace front side and the second brace rear side, wherein the second rail front side is attached to the second brace front side, wherein the second rail rear side is attached to the second brace rear side, and wherein the second rail web and the second brace web are opposite each other.

2. The ladder of claim 1, and further comprising a central brace section that extends from the first brace section to the second brace section;

3. The ladder of claim 2, and further comprising a first support that extends from the first brace section to the central brace section and a second support that extends from the second brace section to the central brace section.

4. The ladder of claim 1, wherein the support brace comprises a front brace section and a rear brace section that mate together.

5. The ladder of claim 4, wherein the front brace section and the rear brace section are fastened together.

6. The ladder of claim 4, wherein the front brace section includes a plurality of front posts, wherein the rear brace section includes a plurality of rear posts, and wherein the front posts mate with the rear posts when the front brace section is attached to the rear brace section.

7. The ladder of claim 4, wherein the front brace section includes a front reinforcing member, wherein the rear brace section includes a rear reinforcing member, and wherein the front and rear reinforcing members mate with each other when the front brace section is attached to the rear brace section.

8. The ladder of claim 1, wherein the support brace is integrally attached to the first step.

9. The ladder of claim 1, wherein the support brace is fixedly attached to the first step.

10. The ladder of claim 1, and further comprising a third ladder rail having a third rail front side, a third rail rear side, and a third rail web that extends between the third rail front side and the third rail rear side;
a fourth ladder rail having a fourth rail front side, a fourth rail rear side, and a fourth rail web that extends between the fourth rail front side and the fourth rail rear side;
a first cross-support attached to the third ladder rail and the fourth ladder rail;
a support brace comprising;
a first brace section having a first brace front side, a first brace rear side, and a first brace web that extends between the first brace front side and the first brace rear side, wherein the third rail front side is attached to the first brace front side, and wherein the third rail rear side is attached to the first brace rear side, and wherein the third rail web and the first brace web are opposite each other;
a second brace section having a second brace front side, a second brace rear side, and a second brace web that extends between the second brace front side and the second brace rear side, wherein the fourth rail front side is attached to the second brace front side, wherein the fourth rail rear side is attached to the second brace rear side, and wherein the fourth rail web and the second brace web are opposite each other.

11. The ladder of claim 10, wherein the support brace is integrally attached to the cross-support.

12. The ladder of claim 10, wherein the support brace is fixedly attached to the cross-support.

13. A ladder comprising:
a first ladder rail having a first rail front side, a first rail rear side, and a first rail web that extends between the first rail front side and the first rail rear side;
a second ladder rail having a second rail front side, a second rail rear side, and a second rail web that extends between the second rail front side and the second rail rear side;
a first step attached to the first ladder rail and the second ladder rail;
a support brace comprising;
a front brace portion comprising;
a first front brace section having a first front brace, wherein the first rail front side is attached to the first front brace side; and
a second front brace section having a second front brace side, wherein the second rail front side is attached to the second front brace side;
a rear brace portion attached to the front brace portion, the rear brace portion comprising;
a first rear brace section having a first rear brace side, wherein the first rail rear side is attached to the first rear brace side; and
a second brace section having a second rear brace side, wherein the second rail rear side is attached to the second rear brace side.

14. The ladder of claim 13, and further comprising a central brace section that extends from the first front brace section and first rear brace section to the second front brace section and second rear brace section;

15. The ladder of claim 14, and further comprising a first support that extends from the first front brace section and first rear brace section to the central front brace section and central rear brace section and a second support that extends from the second front brace section and second rear brace section to the central front brace section and central rear brace section;

16. The ladder of claim 13, wherein the support brace comprises a front brace section and a rear brace section that mate together.

17. The ladder of claim 16, wherein the front brace section and the rear brace section are fastened together.

18. The ladder of claim 16, wherein the front brace section includes a plurality of front posts, wherein the rear brace section includes a plurality of rear posts, and wherein the front posts mate with the rear posts when the front brace section is attached to the rear brace section.

19. The ladder of claim 16, wherein the front brace section includes a front reinforcing member, wherein the rear brace section includes a rear reinforcing member, and wherein the front and rear reinforcing members mate with each other when the front brace section is attached to the rear brace section.

20. A method of bracing a ladder comprising;
providing a ladder having a first ladder rail, a second ladder rail, and a first step, wherein the first ladder rail has a first rail front side, a first rail rear side, and a first rail web that extends between the first rail front side and the first rail rear side, wherein the second ladder rail has a second rail front side, a second rail rear side, and a second rail web that extends between the second rail front side and the second rail rear side, and wherein the first step is attached to the first ladder rail and the second ladder rail; and
attaching a support brace to the first ladder rail, the second ladder rail and the first step, wherein the support brace has a first brace section, a second brace section, and a central brace section, wherein the first brace section has a first brace front side, a first brace rear side, and a first brace web that extends between the first brace front side and the first brace rear side, wherein the first rail front side is attached to the first brace front side, wherein the first rail rear side is attached to the first brace rear side, and wherein the first rail web and the first brace web are opposite each other, wherein the second brace section has a second brace front side, a second brace rear side, and a second brace web that extends between the second brace front side and the second brace rear side, wherein the second rail front side is attached to the second brace front side, wherein the second rail rear side is attached to the second brace rear side, wherein the second rail web and the second brace web are opposite each other, wherein the central brace section extends from the first brace section to the second brace section brace section, and wherein the central brace section is attached to an underside surface of the first step.

21. The method of claim 20, and further comprising providing a first support that extends from the first brace section to the central brace section and a second support that extends from the second brace section to the central brace section.

22. The method of claim 20, and further comprising providing a front brace section and a rear brace section that mate together.

23. The method of claim 22, wherein the front brace section includes a plurality of front posts, wherein the rear brace section includes a plurality of rear posts, and wherein the front posts mate with each other when the front brace section is attached to the rear brace section.

24. The method of claim 22, wherein the front brace section includes a front reinforcing member, wherein the rear brace section includes a rear reinforcing member, and wherein the front and rear reinforcing members mate with each other when the front brace section is attached to the rear brace section.

25. The method of claim 22, wherein the front brace section and the rear brace section are fastened together.

26. A ladder comprising:
a first ladder rail having a first rail front side, a first rail rear side, and a first rail web that extends between the first rail front side and the first rail rear side;
a second ladder rail having a second rail front side, a second rail rear side, and a second rail web that extends between the second rail front side and the second rail rear side; and
a step assembly attached to the first ladder rail and the second ladder rail, wherein the step assembly comprises:
a first brace section having a first brace front side, a first brace rear side, and a first brace web that extends between the first brace front side and the first brace rear side, wherein the first brace section is attached to the first ladder rail;
a second brace section having a second brace front side, a second brace rear side, and a second brace web that extends between the second brace front side and the second brace rear side, wherein the second brace section is attached to the second ladder rail; and
a central brace section that extends between the first brace section and the second brace section, wherein an upper surface of the central brace section comprises a step.

27. The ladder of claim 26, and further comprising a first support that extends from the first brace section to the central brace section and a second support that extends from the second brace section to the central brace section.

28. The ladder of claim 26, wherein the first brace front side, the second brace front side, and a central brace front side mate with the first brace rear side, the second brace rear side and a central brace rear side, respectively.

29. The ladder of claim 26, wherein the first brace front side, the second brace front side, and a central brace front side are fastened to the first brace rear side, the second brace rear side and a central brace rear side, respectively.

30. The ladder of claim 26, wherein the first brace front side, the second brace front side, and a central brace front side include a plurality of front posts, wherein the first brace rear side, the second brace rear side and a central brace rear side include a plurality of rear posts, and wherein the front posts mate with the rear posts when the first brace front side, the second brace front side, and a central brace front side mate with the first brace rear side, the second brace rear side and a central brace rear side, respectively.

31. The ladder of claim 26, wherein the first brace front side, the second brace front side, and a central brace front side compose a front brace section and wherein the first brace rear side, the second brace rear side and a central brace rear side compose a rear brace section, the front brace section includes a front reinforcing member and the rear brace section includes a rear reinforcing member.

32. The ladder of claim 31, wherein the front and rear reinforcing members mate with each other when the front brace section is attached to the rear brace section.
